(19) United States
(12) Patent Application Publication
(10) Pub. No.: US 2011/0025635 A1
(43) Pub. Date: Feb. 3, 2011

(54) TOUCH AND PROXIMITY SENSITIVE DISPLAY PANEL, DISPLAY DEVICE AND TOUCH AND PROXIMITY SENSING METHOD USING THE SAME

(75) Inventor: Bang-Won Lee, Yongin-si (KR)

Correspondence Address: CANTOR COLBURN LLP, 20 Church Street, 22nd Floor, Hartford, CT, 06103, US

(73) Assignee: ATLAB INC., Yongin-si (KR)

(21) Appl. No.: 12/933,783

(22) PCT Filed: Dec. 19, 2008
(86) PCT No.: PCT/KR2008/007557

§ 371 Date: Sep. 21, 2010

(30) Foreign Application Priority Data
Apr. 22, 2008 (KR) 10-2008-0037143

(51) Int. Cl. G06F 3/041

(52) U.S. Cl. 345/173

(57) ABSTRACT

A touch and proximity sensitive display panel, a display device, and a touch and proximity sensing method using the same are disclosed. The display panel includes a plurality of pixels arranged in a matrix form, a pixel substrate having a pixel electrode arranged in an image output direction, a common substrate having a common electrode arranged at a position facing the pixels, and a panel controller that identifies touch and proximity positions of a touch object by sensing electrostatic capacitances of the pixel electrodes through the data lines in a touch-sensing mode. The display panel can sense the touch and proximity of the touch object without an additional touch screen.

### TECHNICAL FIELD

The present invention relates to a display panel, and more particularly, to a touch and proximity sensitive display panel, a display device, and a touch and proximity sensing method using the same.

### BACKGROUND ART

A touch screen, which is a representative device of devices capable of sensing a touch or proximity, is an input means available in place of a mouse or keyboard. Information may be directly input on a display screen of the touch screen using a finger or stylus. Accordingly, the touch screen is advantageous in that anyone may easily perform an input operation since an input method is intuitive, and is evaluated as an ideal input mean in a graphical user interface (GUI) application. At present, the touch screen is widely used in various fields such as mobile phones, personal digital assistants (PDAs), terminals installed in banks or public offices, medical appliances, and guide display devices. Recently, the demands of touch screens are increasing with the development of flat display devices.

FIG. 1 shows a thin film transistor-liquid crystal display (TFT-LCD) as an example of a display device equipped with a conventional touch screen. As shown in FIG. 1, the TFT-LCD equipped with the conventional touch screen includes a touch sensitive touch screen 20, a display panel 30 for outputting an image by controlling the transmittance of light output from a backlight 40, and the backlight 40 for supplying the light to the display panel 30. As is well known, the backlight 40 is required since the display panel 30 of the TFT-LCD does not emit light by itself.

A protective window 10 is a component for protecting the touch screen 20 and the display panel 30 and is manufactured with a predetermined thickness (for example, 3 mm) for durability. Initially, TFT-LCDs were not equipped with the protective window 10. However as large-sized display devices and mobile display devices are becoming more widely used, most display devices are usually equipped with the protective window 10.

The display panel 30 of the TFT-LCD has a structure in which a liquid crystal 31 is inserted between two transparent substrates 32 and 33 made of thin glass. A common electrode 34 is formed on the common transparent substrate 32 of an upper portion. A plurality of gate lines (not shown) in a horizontal direction and a plurality of data lines (not shown) in a vertical direction are formed on the pixel transparent substrate 33 of a lower portion. In intersection regions between the gate lines and data lines, a plurality of thin film transistors (TFTs) (not shown) are formed in which gates are connected to the gate lines, sources are connected to the data lines, and drains are connected to a plurality of pixel electrodes 35. In general, the common electrode 34 and the pixel electrodes 35 use indium tin oxide (ITO) as a transparent conductive material.

Each of the pixel electrodes 35 configures one pixel. When the TFT activated in response to a signal applied through the gate line applies a display voltage received through the data line to the pixel electrode 35, an arrangement of the liquid crystal 31 between the pixel electrodes 35 and the common electrode 34 varies with an electric field therebetween. On the other hand, two polarizing films 36 arranged on an upper portion of the common transparent substrate 32 and a lower portion of the pixel transparent substrate 33 are vertical to a polarization direction of each other. The light transmittance of the display panel 30 varies with the polarization direction of the two polarizing films 36 and the liquid crystal arrangement, such that an image is output by transmitting and controlling the light emitted from the backlight 40 through the two polarizing films 36 and the liquid crystal. When the display panel 30 is a color display panel for outputting a color image, a color filter (not shown) is further provided between the common transparent substrate 32 and the upper polarizing film 36. The color filter has three types of filters for filtering and outputting three-color components of Red, Green, and Blue of light to pass through the display panel 30. A black matrix (not shown) for eliminating color interference is provided between the filters. In the color display panel 30, a combination of three colors of RGB configures one pixel of an image output from the display panel, such that the three pixel electrodes 35 form one pixel.

The touch screen 20 shown in FIG. 1 is capacitive touch screen. Touch screens may be classified as resistive film touch screens, capacitive touch screens, optical touch screens, ultrasonic touch screens, and electromagnetic inductive touch screens according to touch-position measurement methods. Among the touch screens as mentioned above, the capacitive touch screen capable of easily sensing a touch position without reception of direct pressure is most preferred in a display device equipped with the protective window 10.

The sensing sensitivity of the capacitive touch screen 20 is determined by a space between a sensing electrode 21 of the touch screen and a touch or proximity object (for example, a finger) and a dielectric constant. As described above, the thickness of the protective window 10 should be maintained at a predetermined level or more. To increase the sensing sensitivity, the touch screen 20 should adhere closely to a lower portion of the protective window 10. On the other hand, electrostatic capacitance is generated as offset capacitance between the electrode of the touch screen 20 and the display panel 30. The offset capacitance should be removed if possible. Since various signals for controlling the display panel 30 are applied thereto, noise may easily occur. To minimize the offset capacitance and noise, a spacing gap or a film may be additionally inserted between the touch screen 20 and the display panel 30.

Consequently, in the display device equipped with the conventional touch screen, the thickness of the protective window 10 is fixed at the predetermined level or more. It is difficult to reduce the thickness of the panel 30 or the backlight 40. In particular, there is a problem in that the thickness T1 of the entire display device increases due to the thickness of the touch screen 20 caused by the spacing inserted between the touch screen 20 and the display panel 30. Manufacturing cost increases by separately manufacturing the touch screen of the display device and an existing touch screen does not provide a multi-touch function. In order to reduce a manufacturing cost and increase touch sensitivity, area of sensing electrode can not be small so that the existing touch screen has only low sensing resolution.

### DISCLOSURE OF INVENTION

### Technical Problem

The present invention provides a display panel that can reduce a thickness of a touch and proximity sensitive display device, reduce manufacturing cost, maximize touch and proximity sensing resolution, and provide a multi-touch function, and sense a touch and proximity without an additional mean.

The present invention also provides a display device equipped with the touch and proximity sensitive display panel.

The present invention also provides a touch and proximity sensing method using the display panel.

### Technical Solution

According to an aspect of the present invention, there is provided a display panel including: a pixel substrate arranged in an image output direction, the pixel substrate having a plurality of pixels connected to a plurality of gate lines and a plurality of data lines and arranged in a matrix form, each of the pixels having a thin film transistor with a gate connected to a corresponding gate line of the plurality of gate lines, a source connected to a corresponding data line of the plurality of data lines, and a drain connected to a corresponding pixel electrode of a plurality of pixel electrodes; a common substrate that receives a common voltage and has a common electrode arranged at a position facing the pixel; and a panel controller that controls an image to be displayed by applying a display voltage to the pixels through the data line in a display mode and identifies touch and proximity positions of a touch object by sensing electrostatic capacitances of the pixel electrodes through the data lines in a touch-sensing mode.

The panel controller may have the display mode and the touch-sensing mode.

The panel controller may set a display mode period to be longer than a touch-sensing mode period.

The panel controller may activate the gate lines in the display mode and output the display voltage to the pixels through the data lines while the gate lines are activated, and the panel controller may activate each of the gate lines or a predetermined number of gate lines in a group in the touch-sensing mode, select each of the data lines or a predetermined number of data lines in a group, and sense electrostatic capacitance of the assigned pixel electrode.

The panel controller may include: a gate driver that sequentially activates the gate lines in the display mode in response to a first control signal and activates a predetermined number of gate lines or a predetermined group of gate lines in the touch-sensing mode in response to the first control signal; a data driving and sensing unit that outputs the display voltage to the data lines in the display mode in response to a second control signal and outputs touch data by selecting a predetermined number of data lines or a predetermined group of data lines in the touch-sensing mode in response to the second control signal and sensing electrostatic capacitance of the corresponding pixel electrodes; and a controller that outputs the first and second control signals in response to an external command and identifies the touch position of the touch object by receiving the touch data in the touch-sensing mode.

The data driving and sensing unit may include: a data driver that outputs the display voltage to the data lines in response to the second control signal in the display mode and sequentially selects each of the data lines or a predetermined number of data lines in a group in response to the second control signal in the touch-sensing mode; and a sensor that senses electrostatic capacitance of the pixel electrode through the data line selected by the data driver in the touch-sensing mode, and outputs the touch data in response to the electrostatic capacitance.

The sensor may include: at least one time-to-digital converting circuit.

According to another aspect of the present invention, there is provided a display device including: a display panel including a pixel substrate arranged in an image output direction, the pixel substrate having a plurality of pixels connected to a plurality of gate lines and a plurality of data lines and arranged in a matrix form, each of the pixels having a thin film transistor with a gate connected to a corresponding gate line of the plurality of gate lines, a source connected to a corresponding data line of the plurality of data lines, and a drain connected to a corresponding pixel electrode of a plurality of pixel electrodes, a common substrate that receives a common voltage and has a common electrode arranged at a position facing the pixel, and a panel controller that identifies a touch or proximity position of a touch object by sensing electrostatic capacitances of the pixel electrodes in a touch-sensing mode; and a protective window that adheres closely to an upper portion of the pixel substrate and protects the display panel.

The panel controller may sequentially activate the gate lines in a display mode and output the display voltage to the pixels through the data lines when the gate lines are activated, and the panel controller may activate each of the gate lines or a predetermined number of gate lines in a group in the touch-sensing mode, select each of the data lines or a predetermined number of data lines in a group, and sense electrostatic capacitance of the pixel electrode.

The panel controller may include: a gate driver that sequentially activates the gate lines in the display mode in response to a first control signal and activates a predetermined number of gate lines or a predetermined group of gate lines in the touch-sensing mode in response to the first control signal; a data driving and sensing unit that outputs the display voltage to the data lines in the display mode in response to a second control signal and outputs touch data by selecting a predetermined number of data lines or a predetermined group of data lines in the touch-sensing mode in response to the second control signal and sensing electrostatic capacitance of the corresponding pixel electrodes; and a controller that outputs the first and second control signals in response to an external command and identifies the touch position of the touch object by receiving the touch data in the touch-sensing mode.

When the display device is in a standby mode or a power save mode, the panel controller may sense electrostatic capacitance by integrating all the pixel electrodes and sense the proximity of the touch object.

The panel controller may be switched to the power save mode when the touch data is smaller than a predetermined threshold value in the standby mode and may be switched to the display mode when the touch data the touch data is greater than the predetermined threshold value in the power save mode.

The panel controller may output the first and second control signals such that the display panel displays at least one selection region selectable by a user in the display mode, and output the first and second control signals such that a touch region for sensing a touch and proximity corresponding to the at least one selection region is set to be smaller than the at least one selection region when the at least one selection region is densely arranged in the touch-sensing mode and the touch region corresponding to the at least one selection region is set to be larger than the at least one selection region when the at least one selection region is sparsely arranged.

According to still another aspect of the present invention, there is provided a touch and proximity sensing method for use in a display panel, wherein the display panel includes a pixel substrate arranged in an image output direction, the pixel substrate having a plurality of pixels connected to a plurality of gate lines and a plurality of data lines and arranged in a matrix form, each of the pixels having a thin film transistor with a gate connected to a corresponding gate line of the plurality of gate lines, a source connected to a corresponding data line of the plurality of data lines, and a drain connected to a corresponding pixel electrode of a plurality of pixel electrodes, and a common substrate that receives a common voltage and has a common electrode arranged at a position facing the pixel. The touch and proximity sensing method includes: an image display step of displaying an image by applying a display voltage to the pixels through the data line in a display mode; and a touch identification step of identifying a touch and proximity position of a touch object by sensing electrostatic capacitances of the pixel electrodes through the data lines in a touch-sensing mode.

The image display step may include: a selection region display step of displaying at least one selection region selectable by a user on the display panel.

The touch identification step may include: a first touch region setting step of setting a touch region for sensing a touch and proximity corresponding to the at least one selection region to be smaller than the at least one selection region when the at least one selection region is densely arranged; and a second touch region setting step of setting the touch region corresponding to the at least one selection region to be larger than the at least one selection region when the at least one selection region is sparsely arranged.

The display panel may further include a standby mode and a power save mode. The touch and proximity sensing method may further include: a power save mode switching step of switching to the power save mode when the proximity of the touch object is not sensed by integrating all the pixel electrodes and sensing the electrostatic capacitance in the standby mode; and a display mode switching step of switching to the display mode when the proximity of the touch object is sensed by integrating all the pixel electrodes and sensing the electrostatic capacitance in the power save mode.

### Advantageous Effects

In a touch and proximity sensitive display panel, a display device, and a touch and proximity sensing method using the same according to the present invention, pixel electrodes of the display panel are used as a sensing electrode of a touch screen, such that the display panel can sense a touch and proximity of a touch object. The thickness of the display device can be significantly reduced by omitting an additional touch screen. Since the pixel electrodes are used as the sensing electrode, the touch and proximity sensing resolution can be identical with the resolution of the display panel. Various resolutions desired by a user and touch regions can be freely set. A multi-touch operation can be sensed. Manufacturing cost and power consumption can be reduced.

### BRIEF DESCRIPTION OF THE DRAWINGS

FIG. 1 shows an example of a display device equipped with a conventional touch screen.

FIG. 2 shows an example of a display device equipped with a touch and proximity sensitive display panel according to the present invention.

FIG. 3 is a schematic plan view of the display panel of FIG. 2.

FIG. 4 shows an example of a sensing circuit provided in a data driving and sensing unit of FIG. 3.

FIG. 5 shows another example of a display device equipped with a touch and proximity sensitive display panel according to the present invention.

FIG. 6 shows an example of using the display device according to the present invention.

### MODE FOR THE INVENTION

Hereinafter, a touch and proximity sensitive display panel, a display device, and a touch and proximity sensing method using the same will be described with reference to the accompanying drawings.

With the extension of a use field of various sensors, efforts for improving a sensing function of a sensor are being continued. As compared with the conventional sensors, new sensors have significantly improved sensing capability. And a technique for eliminating an offset or noise from a sensor has significantly developed. According to this trend, the technology of touch sensors has significantly developed.

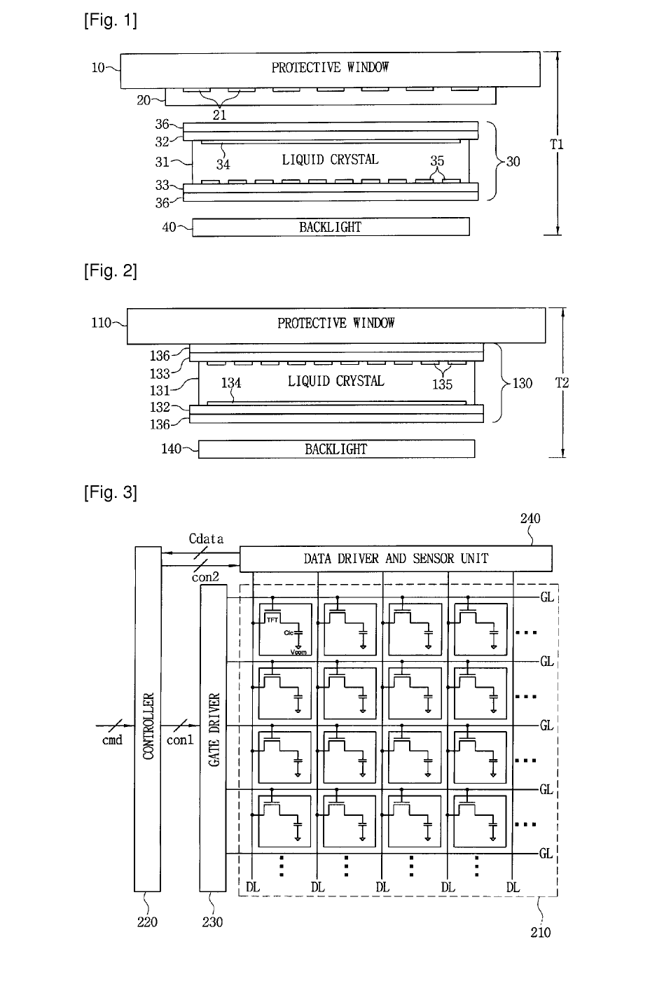

A display device of the present invention different from the display device shown in FIG. 1 has a display panel capable of directly sensing a touch and proximity without a touch screen separated from the display panel.

FIG. 2 shows an example of a display device equipped with a touch and proximity sensitive display panel according to the present invention.

A protective window 110 and a backlight 140 of FIG. 2 are the same as the protective window 10 and the backlight 40 of FIG. 1. However, the display device of FIG. 2 does not have a separate touch screen. The display panel 130 of FIG. 2 has a structure in which the front side and backside of the display panel 30 of FIG. 1 have been reversed. The display panel 130 adheres closely to a lower portion of the protective window 110. In FIG. 1, the common transparent substrate 32 is arranged on the upper portion of the display panel 30 and the pixel transparent electrode 35 is arranged on the lower portion thereof, such that the common electrode 34 is arranged on the upper portion and the pixel electrodes 35 are arranged on the lower portion. However, in FIG. 2, a pixel transparent substrate 133 is arranged on an upper portion of the display panel 130 and a common transparent substrate 132 is arranged on a lower portion thereof, such that pixel electrodes 135 are arranged on the upper portion and a common electrode 134 is arranged on the lower portion.

When the display device is configured with the reversed display panel 130, the reversed display panel 130 adheres closely to the protective window 110. The thickness of the transparent substrates 132 and 133 and the polarizing films 136 are thinner than the thickness of the protective window 110. Accordingly, the pixel electrodes 135 of the display panel 130 are very close to the protective window 110. The thickness of the transparent substrate 132 and 133 available in general is about 500˜700 μm and the thickness of the polarizing films 136 is about 100˜200 μm. That is, a difference between a distance from an upper surface of the protective window 10 of FIG. 1 to the sensing electrode 21 of the touch screen 20 and a distance from an upper surface of the protective window 110 of FIG. 2 to the pixel electrode 135 of the display panel 130 is small. Accordingly, since the electrostatic capacitance of the pixel electrode 135 of FIG. 2 can be varied when an object touches the upper surface of the protective window 110, the pixel electrode 135 can have the same function as the sensing electrode 21 of FIG. 1.

As described above, the display panel 130 outputs an image by varying the transmittance of light emitted from the backlight 140 according to the polarization direction of the two polarizing films 136 and the liquid crystal arrangement. The liquid crystal arrangement varies with an electric field generated between the pixel electrodes 135 and the common electrode 134. Even in the reversed display panel 130 as shown in FIG. 2, the electric field to be generated between the pixel electrode 135 and the common electrode 134 is identical and therefore the liquid crystal arrangement is identically varied, such that a normal image can be output.

That is, the display panel 130 of FIG. 2 can be provided with both an image output function of the display panel 30 of FIG. 1 and a function of the touch screen 20.

As compared with a size of the display device of FIG. 1, a size of the display device of FIG. 2 can be further reduced by the thickness of the touch screen 20 and the spacing between the touch screen 20 and the upper polarizing film 36 of the display panel, thereby reducing the thickness T2 of the entire display device. For convenience of explanation, a TFT-LCD display (active matrix-liquid crystal display (AM-LCD)) structure has been described so far. When an active matrix-organic light emitting diode (AM-OLED) is applied, the thickness can be further reduced since the backlight 140 is not required.

FIG. 3 is a schematic plan view of the display panel 130 of FIG. 2.

In FIG. 3, the display panel 130 includes a pixel array 210, a controller 220, a gate driver 230, and a data driving and sensing unit 240.

The pixel array 210 is formed between the two transparent substrates 132 and 133.

On the pixel transparent substrate 133 arranged on the upper portion of FIG. 2, a plurality of gate lines GL vertically intersect with a plurality of data lines DL. In intersection regions between the gate lines GL and the data lines DL, a plurality of TFTs are respectively formed in which gates are connected to a corresponding gate line of the plurality of gate lines GL, sources are connected to a corresponding data line of the plurality of data lines DL, and drains are connected to a corresponding pixel electrode of a plurality of pixel electrodes 135. Here, the TFT serves as a switch transistor. When the gate line GL is activated, the TFT is turned on and therefore the data line DL and the pixel electrode 135 are electrically connected.

On the other hand, the common electrode 134 is formed on the common transparent substrate 132 arranged on the lower portion of FIG. 2.

A liquid crystal capacitor Clc of which one end is connected to the drain of the TFT of FIG. 3 uses the liquid crystal between the common transparent substrate 132 and the pixel transparent substrate 133 as a dielectric and is formed using the pixel electrode 135 and the common electrode 134 as both electrodes thereof. Since a common voltage Vcom is applied to the common electrode 134 of the TFT-LCD, the other end of the liquid crystal capacitor Clc is connected to the common voltage Vcom.

In response to a first control signal con1 applied from the controller 220, the gate driver 230 activates a designated number of gate lines GL among the gate lines GL and activates corresponding TFTs. In response to a second control signal con2 applied from the controller 220, the data driving and sensing unit 240 outputs a display voltage to data lines DL. In general, the gate driver 230 selects and activates only one gate line GL in sequence. However, as the size of the display panel recently increases, at least two gate lines GL are configured to be simultaneously activated. Otherwise, when a plurality of pixel arrays 210, a plurality of gate drivers 230, and a plurality of data driving and sensing units 240 are provided, a plurality of gate lines GL and a plurality of data lines DL can be simultaneously selected and activated.

In the present invention, the data driving and sensing unit 240 senses a variation of electrostatic capacitance of the pixel electrodes 135 through the data lines DL and outputs touch data Cdata to the controller 220 by identifying whether there is a touch of the touch object. That is, when it is determined that the touch object touches the protective window 110, the touch data Cdata is output to the controller 220.

In response to a command cmd applied from an outside source, the controller 220 outputs the first control signal con1 for controlling the gate driver 230 and the second control signal con2 for controlling the data driving and sensing unit 240. The controller 220 identifies the touch position by receiving and analyzing the touch data Cdata output from the data driving and sensing unit 240 and performs a predetermined operation corresponded to the touch position. Here, the touch position can be identified using the gate line GL activated by the gate driver 230 and the data line DL sensed by the data driving and sensing unit 240. In FIG. 3, the controller 220 is arranged inside the display panel 130. Otherwise, the controller 220 may be arranged outside the display panel 130.

The operation of the touch and proximity sensitive display panel will be described with reference to FIGS. 2 and 3. A basic function of the display panel 130 is to output an image. When the display panel 130 outputs the image, a display voltage is applied to the pixel electrodes 135 through the data lines DL and the TFTs. Accordingly, it is difficult to use the pixel electrodes 135 for outputting the image as a sensor for sensing electrostatic capacitance, simultaneously.

As described above, the controller 220 outputs the first control signal con1 to the gate driver 230 in response to the external command cmd in a display mode, and the gate driver 230 selects and activates a predetermined number of gate lines among the gate lines GL in response to the first control signal con1. The activated gate lines GL activate TFTs of the pixel array 210 in a row unit. The controller 220 outputs the second control signal con2 to the data driving and sensing unit 240. In response to the second control signal con2, the data driving and sensing unit 240 outputs a display voltage at a designated level to the data lines DL. The TFTs connected to the activated gate lines GL and the data lines DL apply the display voltage applied through the data lines DL to the pixel electrodes 135. That is, when the gate lines GL are activated, the display voltage at the designated level is applied to the data lines DL, such that the voltage is applied to the pixel electrodes 135.

The TFT-LCD display panel 130 outputs an image by controlling an amount of transmitted light output from the backlight 140 in multiple steps. The amount of transmitted light is controlled using a level of the display voltage applied to the pixel electrodes 135. That is, the display voltage applied to the pixel electrodes 135 through the data lines DL controls the transmittance of light emitted from the backlight 140 in the display panel 130. In general, the display voltage has an 8-bit level of 256 steps. The display panel 130 displays a frame as a unit in which all the pixel electrodes are selected once. A display device such as a television (TV) based on a national television system committee (NTSC) standard displays at least 60 frames per second. The number of frames per second to be displayed is expressed by a frame rate and a unit of the frame rate is frames/sec. In a full high definition (HD) TV currently being released, the display panel 130 has at least (1920×1080) pixels. That is, the full HD TV outputs an image by applying the voltage to at least (1920×1080) pixels at least 60 times per second. A mobile display device has a smaller size and lower resolution than the TV. In general, the mobile display device has quarter video graphics array (QVGA) resolution of (320×240) pixels or more and displays images of at least 30 frames per second.

As described above, many display devices output images at a frame rate of at least 60 frames per second. Even when 1˜2 frames are omitted, a user does not perceive the omitted frames. In the present invention, when the display device does not output images of 1˜2 frames at a designated frame rate, the pixel electrodes 135 are used as a sensing electrode. For example, the display device having the 60 frame rate outputs images of 58 frames per second and a touch is sensed during two frames. When the display device has a low frame rate of 20 frames per second, the display device should output all frame images for image quality. In this case, the number of frames per second in the display device is increased by 1˜2, the duration of 1˜2 frames can be used to sense a touch at an increased frame rate. That is, a frame rate of 20 frames per second in the display device is adjusted to a frame rate of 22 frames per second and the duration of 2 frames can be used to sense a touch. For a fast touch sensing operation, a touch can be sensed after every frame. For this, a touch sensing time should be minimized such that the user does not perceive a variation of a frame rate.

The operation of the display panel 130 used as the touch screen will be described with reference to FIGS. 2 and 3. Periodically or in response to the external command cmd, the controller 220 enters a touch-sensing mode and outputs the first control signal con1 and the second control signal con2 corresponding to the touch-sensing mode. Basically, the controller 220 periodically enters the touch-sensing mode. However, the controller 220 may not periodically enter the touch-sensing mode in the mobile display device. For example, when a hold function is set in the display device, the controller 220 should not enter the touch-sensing mode. Since touch-sensing regions can be variously set according to statuses of the display device, the controller 220 is configured to receive the external command cmd.

In response to the first control signal con1, the gate driver 230 activates a predetermined number of gate lines GL. In response to the second control signal con2, the data driving and sensing unit 240 senses electrostatic capacitance of the pixel electrodes 135 connected through a predetermined number of data lines DL. If the gate lines GL and the data lines DL are sequentially selected one by one, all the pixel electrodes 135 of the display panel 130 are used as individual sensing electrodes. That is, the resolution of the display panel 130 becomes the resolution of the touch screen. Accordingly, a high-resolution touch screen can be implemented without any special process. As described above, the display device has a frame rate indicating the number of times of selecting all the pixel electrodes 135 for 1 sec. Accordingly, the display device having 60 frame rates sequentially selects all the pixel electrodes 135 once for 1/60 sec. The touch screen of the present invention (herein “display panel”) different from the conventional touch screen can correctly sense the touch or proximity since the sensing electrodes (herein “pixel electrodes”) sequentially sense the touch or proximity of the touch object even when the touch object has a simultaneous touch or proximity to the sensing electrodes. Since a period of time in which the sensing electrodes sequentially sense the touch or proximity of the touch object is very short, the display panel of the present invention has substantially the same function as the touch screen for sensing a multi-touch operation (for example, for 1/60 sec).

An example in which the touch and proximity of the touch object can be sensed has been described. Since the display panel 130 of the present invention operates in the same manner as that of the capacitive touch screen, the electrostatic capacitance of the pixel electrodes 135 is varied when a touch object of very large electrostatic capacitance has the proximity without any touch, such that the data driving and sensing unit 240 can perform a sensing operation.

On the other hand, the gate driver 230 and the data driving and sensing unit 240 can respectively select the gate lines GL and the data lines DL in response to the first and second control signals con1 and con2. For example, when the gate driver 230 sequentially selects the gate lines GL two by two and the data driving and sensing unit 240 senses electrostatic capacitance applied through two data lines DL, four pixel electrodes 135 can be used as one sensor electrode once. The display panel 130 of the present invention can operate as the touch screen having the display resolution corresponding to the number of pixel electrodes 135. The case where the touch screen of the display resolution is required in an actual operation is almost uncommon. Since the display panel 130 of the present invention can use a plurality of pixel electrodes 135 as one sensing electrode by controlling the number of gate lines GL and data lines DL to be simultaneously selected in the touch-sensing mode, the resolution of the touch screen can be freely controlled.

When the pixel electrodes 135 are used as one sensing electrode, an area of the sensing electrode can increase. The increased area of the sensing electrode leads to the improvement of sensing sensitivity since electrostatic capacitance increases when an area of both ends of a capacitor increases. The sensing sensitivity can be improved in various methods in the mobile display device. For example, when the mobile display device is in a standby mode, all the gate lines GL are activated. When a sensing circuit (not shown) provided in the data driving and sensing unit 240 senses electrostatic capacitance through all the data lines DL, all the pixel electrodes 135 are used as one sensing electrode, such that the sensing sensitivity can be maximized and the proximity of the touch object can be sensed with high sensitivity. When there is no proximity of the touch object (or touch data Cdata is low than a predetermined threshold value) in the standby mode, the mobile display device can determine that the user is not in the proximity thereof. As a result, the mobile display device is switched to a power save mode, thereby reducing power consumption.

When the display device of the present invention is used as the touch screen, touch-sensing regions as well as touch and proximity sensing resolutions can be freely set by variously combining the gate lines GL and the data lines DL. That is, when the gate driver 230 of FIG. 3 activates only second and third gate lines GL and the data driving and sensing unit 240 senses electrostatic capacitance through only second to fourth data lines DL, only six pixel electrodes 135 of the pixel array 210 are used as the sensing electrode and the remaining pixel electrodes 135 are not used as the sensing electrode.

Since the data driving and sensing unit 240 can sense electrostatic capacitance of each of the pixel electrodes or sequentially sense electrostatic capacitance in a unit of a predetermined number of pixel electrodes, the touch and proximity sensor can cover in all regions of the display panel even when only one sensing circuit is used. In this regard, the sensing circuit should have a very fast operating rate. When all of the pixel electrodes are individually used in the touch mode within one frame interval, a time in which the sensing circuit senses the electrostatic capacitance of each pixel electrode can be expressed by 1/(Frame Rate×Resolution) sec. In a QVGA display device having a frame rate of 60 frames per second, the sensing time is a relatively short time of 1/(60×320×280) sec. When the sensing circuit does not sense the electrostatic capacitance within the relatively short time as described above, the time in which the sensing circuit senses the electrostatic capacitance of the sensing electrode can be significantly increased by employing a plurality of pixel electrodes 135 as one sensing electrode. Of course, the data driving and sensing unit 240 can include a plurality of sensing circuits.

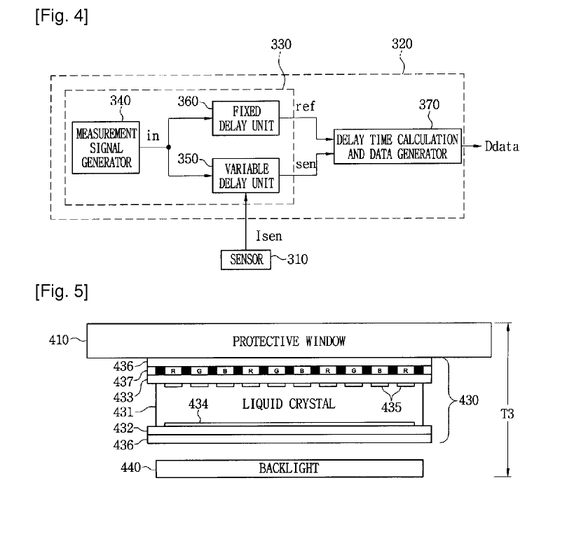

FIG. 4 shows an example of a sensing circuit provided in the data driving and sensing unit of FIG. 3.

In the present invention, the sensing circuit provided in the data driving and sensing unit 240 can be any circuit capable of sensing the electrostatic capacitance. The sensing circuit should eliminate an offset and noise and operate very high speed since the pixel electrodes 135 of the present invention are used as the sensing electrode of the touch screen. FIG. 4 shows an example of a sensing circuit 320 capable of satisfying the above-described conditions as a time-to-digital converting circuit disclosed in Korean Patent No. 0728654.

An operation of the time-to-digital converting circuit 320 of FIG. 4 will be described. The time-to-digital converting circuit 320 includes a delay time-varying unit 330 and a delay time calculation and data generator 370. The delay time-varying unit 330 includes a measurement signal generator 340, a variable delay unit 350, and a fixed delay unit 360.

A sensor 310 has a variable impedance value Isen according to external stimulus strength. The sensor 310 can use all types of devices in which an electrostatic capacitance, inductive or resistance value is variable.

The delay time-varying unit 330 generates a sensing signal sen and a reference signal ref having a delay time difference variable in proportion to the impedance value Isen of the sensor 310. For this, the measurement signal generator 340 generates a measurement signal in clocked in a period of a first time and applies the measurement signal in to the variable delay unit 350 and the fixed delay unit 360. The variable delay unit 350 is electrically connected to the sensor 310 and generates the sensing signal sen by delaying the measurement signal in according to an impedance value of the sensor 310. The fixed delay unit 360 generates the reference signal ref by a predetermined value or a control scheme.

The delay time calculation and data generator 370 receives the reference signal ref and the sensing signal sen, computes a delay time difference of the reference signal ref and the sensing signal sen, and generates digital data Ddata having a value corresponding to the computed delay time difference.

Accordingly, when the pixel electrode 135 of the present invention is used as the capacitance variable sensor 310 of the time-to-digital converting circuit 320, the time-to-digital converting circuit 320 can be used as the sensing circuit of the present invention. Since the time-to-digital converting circuit 320 outputs the digital data Ddata, the data driving and sensing unit 240 easily generates touch data Cdata in response to the digital data Ddata. A touch pressure of the touch object as well as the touch and proximity can be measured using the digital data Ddata of the time-to-digital converting circuit 320. When the display panel is configured to measure the touch pressure using the digital data Ddata of the time-to-digital converting circuit 320, the display device can be configured to perform different functions according to touch pressures even when the touch object is in contact with the same position. It is natural that if the protective window 110 is flexible, then touch generates a pressure signal that causes capacitance changes or voltage changes between the pixel electrode 135 and common electrode 134 and the time-to-digital converter circuit 320 measures the capacitance changes or the voltage change.

The sensing circuit of the present invention is not limited to the time-to-digital converting circuit of FIG. 4.

FIG. 5 shows another example of a display device equipped with a touch and proximity sensitive display panel according to the present invention, and shows a display panel 430 having a color filter 437 added to the display panel 130 of FIG. 2.

When the display panel is a color display panel for outputting a color image, the conventional display panel 30 further includes a color filter (not shown) between the common transparent substrate 32 and the polarizing film 36. In the existing display panel 30, light emitted from the backlight 40 is applied to the color filter (not shown) through the polarizing film 36, the pixel transparent substrate 33, the pixel electrode 35, the liquid crystal 31, the common electrode 34, and the common transparent substrate 32. The light passed through the color filter is applied to the protective window 10 through the polarizing film 36. That is, the light emitted from the backlight 40 passes through the color filter after passing through the liquid crystal 31.

In the present invention, the display panel is vertically reversed such that the pixel electrodes of the display panel are used as the sensing electrode. When the existing color display panel is directly applied to the present invention, the light emitted from the backlight 40 is configured to sequentially pass through the color filter and the liquid crystal. Even when the light first passes through the color filter, the display panel can normally display an image. In a state in which the luminance of light emitted from the backlight is reduced by the color filter, the liquid crystal should control the light by applying the display voltage to the pixel electrode. In the vertically reversed display panel compared with the non-reversed display panel, color display image can be unclear because the light through the color filter can be scattered by the liquid crystal 31.

In the color display panel 430 of FIG. 5, the color substrate 437 is inserted between a polarizing film 436 and a pixel transparent substrate 433 arranged on an upper portion. The other elements except the color substrate 437 are the same as those of the display panel 130 of FIG. 2. That is, the color display panel 430 of FIG. 5 is arranged by vertically reversing the existing display panel. The color filter 437 is arranged such that the light reaches the color filter 437 after the light emitted from a backlight 440 passes through the liquid crystal. Accordingly, the color display panel 430 of FIG. 5 can display an image by performing the same control operation as that of the conventional color display panel.

The TFT-LCD panel serving as the touch and proximity sensitive display panel of the present invention has been described above, but the present invention is not limited to the TFT-LCD panel. That is, the present invention can be applied to other types of display panels such as an AM-OLED panel and the like. When the present invention is applied to the AM-OLED panel, the AM-OLED panel, unlike the TFT-LCD panel, emits light by itself. Accordingly, since the backlight and the polarizing film are not required, the thickness of the display device can be further reduced. In addition, the present invention can be applied to various display panels such as flexible display panels (for example, e-ink) manufactured with a current TFT-LCD panel or an OLED panel.

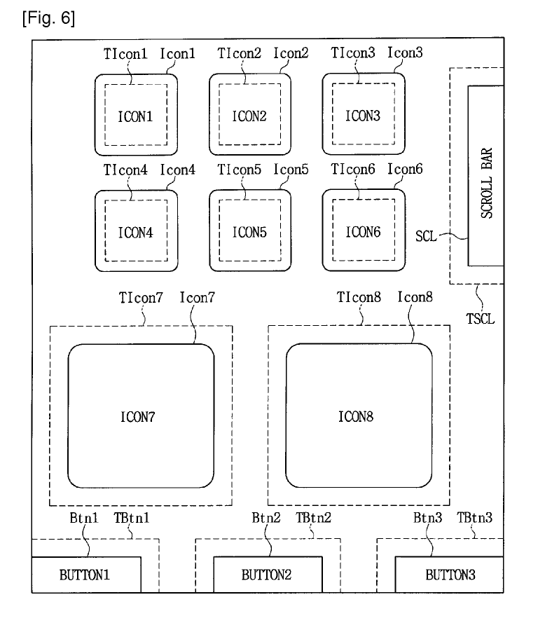

FIG. 6 shows an example of using the display device according to the present invention.

The example of FIG. 6 will be described with reference to FIGS. 2 and 3. First, the controller 220 operates in the display mode. The display panel 130 displays an image with respect to an associated application program. At this time, a frame rate of the display panel 130 is set to 60 frames/sec. During two frames among display frames, the display panel 130 can be set to operate in the touch-sensing mode. That is, the display panel 130 is configured to sense two touches per second. The display panel 130 repeats an operation for displaying images during 29 frames and sensing touches during one frame. It is also natural that touch frequency can be increased up to the display frame rate if touch and proximity sensing circuit is fast enough.

A region indicated by the solid line of FIG. 6 displays selection regions for the user in a current application program and displays six small icons Icon1˜Icon6, two large icons Icon7 and Icon8, three buttons Btn1˜Btn3, and a scroll bar SCL. An arrangement of the selection regions of FIG. 6 will be described. The six small icons Icon1˜Icon6 are relatively densely arranged, but the other two large icons Icon7 and Icon8, the three buttons Btn1˜Btn3, and the scroll bar SCL are relatively sparsely arranged. When one of the six small icons Icon1˜Icon6 serving as the selection regions densely arranged is selected by the user, there is a high possibility that the icon is selected simultaneously with an adjacent icon or another icon. On the other hand, when one of the selection regions sparsely arranged is selected, there is a low possibility that the user selects the region simultaneously with an adjacent selection region and makes a wrong selection operation.

On the other hand, the touch and proximity sensitive display panel of the present invention can freely set a touch and proximity sensing region by controlling the gate driver 230 and the data driving and sensing unit 240 to select the gate lines GL and the data lines DL.

Accordingly, the wrong selection of the user can be prevented by setting touch regions TIcon1˜TIcon6 to be smaller than the icons Icon1˜Icon6 in the selection regions densely arranged. The user convenience can be improved by setting touch regions TIcon7, TIcon8, TBtn1˜TBtn3, and TSCL to be larger than the selection regions Icon7, Icon8, Btn1˜Btn3, and SCL sparsely arranged. The sensing sensitivity can be improved by setting such that each of the pixel electrodes 135 within each of the touch regions TIcon1˜TIcon8 and TBtn1˜TBtn3 corresponding to the icons Icon1˜Icon8 and the buttons Btn1˜Btn3 operates as one sensing electrode. Since the scroll bar SCL should sense the movement of a touch object, a single pixel electrode 135 or a predetermined number of pixel electrodes 135 within the touch region TSCL are set to operate as the sensing electrode.

Since the touch and proximity sensitive display panel of the present invention can perform the sensing operation for only the set touch regions TIcon1˜TIcon8, TBtn1˜TBtn3, and TSCL, the display panel of the present invention can further reduce power consumption in comparison with the display panel equipped with the existing touch screen that unnecessarily performs the sensing operation for all regions and can prevent a wrong operation of the user.

The controller 220, the gate driver 230, and the data driving and sensing unit 240 are separately illustrated, but can be integrated into a panel controller. In the display mode, an image is displayed by applying the display voltage to the pixel electrodes through the data lines. In the touch-sensing mode, the touch and proximity positions can be identified by sensing electrostatic capacitance of the pixel electrodes through the data lines.

While the present invention has been shown and described with reference to certain exemplary embodiments thereof, it will be understood by those skilled in the art that various changes in form and details may be made therein without departing from the spirit and scope of the invention as defined by the appended claims.

1. A display panel comprising:
a pixel substrate arranged in an image output direction, the pixel substrate having a plurality of pixels connected to a plurality of gate lines and a plurality of data lines and arranged in a matrix form, each of the pixels having a thin film transistor with a gate connected to a corresponding gate line of the plurality of gate lines, a source connected to a corresponding data line of the plurality of data lines, and a drain connected to a corresponding pixel electrode of a plurality of pixel electrodes;
a common substrate that receives a common voltage and has a common electrode arranged at a position facing the pixel; and
a panel controller that controls an image to be displayed by applying a display voltage to the pixels through the data line in a display mode and identifies touch and proximity positions of a touch object by sensing electrostatic capacitances of the pixel electrodes through the data lines in a touch-sensing mode.

2. The display panel of claim 1, wherein the panel controller has the display mode and the touch-sensing mode.

3. The display panel of claim 2, wherein the panel controller sets a display mode period to be longer than a touch-sensing mode period.

4. The display panel of claim 1, wherein the panel controller activates the gate lines in the display mode and outputs the display voltage to the pixels through the data lines while the gate lines are activated, and
the panel controller activates each of the gate lines or a predetermined number of gate lines in a group in the touch-sensing mode, selects each of the data lines or a predetermined number of data lines in a group, and senses electrostatic capacitance of the assigned pixel electrode.

5. The display panel of claim 4, wherein the panel controller comprises:
a gate driver that sequentially activates the gate lines in the display mode in response to a first control signal and activates a predetermined number of gate lines or a predetermined group of gate lines in the touch-sensing mode in response to the first control signal;
a data driving and sensing unit that outputs the display voltage to the data lines in the display mode in response to a second control signal and outputs touch data by selecting a predetermined number of data lines or a predetermined group of data lines in the touch-sensing mode in response to the second control signal and sensing electrostatic capacitance of the corresponding pixel electrodes; and
a controller that outputs the first and second control signals in response to an external command and identifies the touch position of the touch object by receiving the touch data in the touch-sensing mode.

6. The display panel of claim 5, wherein the data driving and sensing unit comprises:
a data driver that outputs the display voltage to the data lines in response to the second control signal in the display mode and sequentially selects each of the data lines or a predetermined number of data lines in a group in response to the second control signal in the touch-sensing mode; and
a sensor that senses electrostatic capacitance of the pixel electrode through the data line selected by the data driver in the touch-sensing mode, and outputs the touch data in response to the electrostatic capacitance.

7. The display panel of claim 6, wherein the sensor comprises:
at least one time-to-digital converting circuit.

8. The display panel of claim 7, wherein the at least one time-to-digital converting circuit comprises:
a measurement signal generator that generates a measurement signal;
a fixed delay unit that generates a reference signal by delaying the measurement signal for a predetermined time;
a variable delay unit that generates a sensing signal by delaying the measurement signal in response to the electrostatic capacitance of the pixel electrode applied through the data line; and
a delay time calculation and data generator that measures a delay time difference of the sensing signal with respect to the reference signal and outputs touch data having a value corresponding to the measured delay time difference.

9. The display panel of claim 1, wherein the display panel is a liquid crystal display panel that includes the pixel substrate arranged on a touch or proximity portion of the touch object and senses electrostatic capacitance or proximity of the touch object.

10. The display panel of claim 9, further comprising:
a liquid crystal inserted between the common substrate and the pixel substrate; and
a polarizing film arranged on each of a lower portion of the common substrate and an upper portion of the pixel substrate.

11. The display panel of claim 1, wherein the display panel is an electro-luminance display that comprises the pixel substrate arranged on a touch or proximity portion of the touch object and senses electrostatic capacitance or proximity of the touch object.

12. The display panel of claim 10, further comprising:
a color filter arranged on a side facing the common substrate on the pixel substrate.

13. A display device comprising:
a display panel including a pixel substrate arranged in an image output direction, the pixel substrate having a plurality of pixels connected to a plurality of gate lines and a plurality of data lines and arranged in a matrix form, each of the pixels having a thin film transistor with a gate connected to a corresponding gate line of the plurality of gate lines, a source connected to a corresponding data line of the plurality of data lines, and a drain connected to a corresponding pixel electrode of a plurality of pixel electrodes, a common substrate that receives a common voltage and has a common electrode arranged at a position facing the pixel, and a panel controller that identifies a touch or proximity position of a touch object by sensing electrostatic capacitances of the pixel electrodes in a touch-sensing mode; and
a protective window that adheres closely to an upper portion of the pixel substrate and protects the display panel.

14. The display device of claim 13, wherein the panel controller sequentially activates the gate lines in a display mode and outputs the display voltage to the pixels through the data lines when the gate lines are activated, and
the panel controller activates each of the gate lines or a predetermined number of gate lines in a group in the touch-sensing mode, selects each of the data lines or a predetermined number of data lines in a group, and outputs touch data by sensing electrostatic capacitance of the pixel electrode.

15. The display device of claim 14, wherein the panel controller comprises:
a gate driver that sequentially activates the gate lines in the display mode in response to a first control signal and activates a predetermined number of gate lines or a predetermined group of gate lines in the touch-sensing mode in response to the first control signal;
a data driving and sensing unit that outputs the display voltage to the data lines in the display mode in response to a second control signal and outputs touch data by selecting a predetermined number of data lines or a predetermined group of data lines in the touch-sensing mode in response to the second control signal and sensing electrostatic capacitance of the corresponding pixel electrodes; and
a controller that outputs the first and second control signals in response to an external command and identifies the touch position of the touch object by receiving the touch data in the touch-sensing mode.

16. The display device of claim 15, wherein the data driving and sensing unit comprises:
a data driver that outputs the display voltage to the data lines in response to the second control signal in the display mode and sequentially selects each of the data lines or a predetermined number of data lines in a group in response to the second control signal in the touch-sensing mode; and
a sensor that senses electrostatic capacitance of the pixel electrode through the data line selected by the data driver in the touch-sensing mode, and outputs the touch data in response to the electrostatic capacitance.

17. The display device of claim 16, wherein the sensor comprises:
at least one time-to-digital converting circuit including:
a measurement signal generator that generates a measurement signal;
a fixed delay unit that generates a reference signal by delaying the measurement signal for a predetermined time;
a variable delay unit that generates a sensing signal by delaying the measurement signal in response to the electrostatic capacitance of the pixel electrode applied through the data line; and
a delay time calculation and data generator that measures a delay time difference of the sensing signal with respect to the reference signal and outputs touch data having a value corresponding to the measured delay time difference.

18. The display device of claim 15, wherein when the display device is in a standby mode or a power save mode, the panel controller senses electrostatic capacitance by integrating all the pixel electrodes and senses the proximity of the touch object.

19. The display device of claim 18, wherein the panel controller is switched to the power save mode when the touch data is smaller than a predetermined threshold value in the standby mode and is switched to the display mode when the touch data is greater than the predetermined threshold value in the power save mode.

20. The display device of claim 14, wherein the panel controller alternately switches the display mode and the touch-sensing mode.

21. The display device of claim 20, wherein the panel controller sets a display mode period to be longer than a touch-sensing mode period.

22. The display device of claim 14, wherein the panel controller outputs the first and second control signals such that the display panel displays at least one selection region selectable by a user in the display mode, and outputs the first and second control signals such that a touch region for sensing a touch and proximity corresponding to the at least one selection region is set to be smaller than the at least one selection region when the at least one selection region is densely arranged in the touch-sensing mode and the touch region corresponding to the at least one selection region is set to be larger than the at least one selection region when the at least one selection region is sparsely arranged.

23. The display device of claim 13, wherein the display panel is a liquid crystal display panel.

24. The display device of claim 23, wherein the display panel comprises:
a liquid crystal inserted between the common substrate and the pixel substrate; and
a polarizing film arranged on each of a lower portion of the common substrate and an upper portion of the pixel substrate.

25. The display device of claim 24, wherein the display panel further comprises a color filter between the pixel substrate and the polarizing film arranged on the upper portion of the pixel substrate.

26. The display device of claim 24, further comprising:
a backlight arranged under the display panel to emit light to the display panel.

27. The display device of claim 13, wherein the display panel is an electro-luminance display.

28. A touch and proximity sensing method for use in a display panel, wherein the display panel comprises a pixel substrate arranged in an image output direction, the pixel substrate having a plurality of pixels connected to a plurality of gate lines and a plurality of data lines and arranged in a matrix form, each of the pixels having a thin film transistor with a gate connected to a corresponding gate line of the plurality of gate lines, a source connected to a corresponding data line of the plurality of data lines, and a drain connected to a corresponding pixel electrode of a plurality of pixel electrodes, and a common substrate that receives a common voltage and has a common electrode arranged at a position facing the pixel, the touch and proximity sensing method comprising:
an image display step of displaying an image by applying a display voltage to the pixels through the data line in a display mode; and
a touch identification step of identifying a touch and proximity position of a touch object by sensing electrostatic capacitances of the pixel electrodes through the data lines in a touch-sensing mode.

29. The touch and proximity sensing method of claim 28, wherein the image display step and the touch identification step are alternately switched.

30. The touch and proximity sensing method of claim 29, wherein the image display step comprises:
a selection region display step of displaying at least one selection region selectable by a user on the display panel.

31. The touch and proximity sensing method of claim 30, wherein the touch identification step comprises:
a first touch region setting step of setting a touch region for sensing a touch and proximity corresponding to the at least one selection region to be smaller than the at least one selection region when the at least one selection region is densely arranged; and
a second touch region setting step of setting the touch region corresponding to the at least one selection region to be larger than the at least one selection region when the at least one selection region is sparsely arranged.

32. The touch and proximity sensing method of claim 29, wherein the display panel further comprises a standby mode and a power save mode, and
wherein the touch and proximity sensing method further comprises:
a power save mode switching step of switching to the power save mode when the proximity of the touch object is not sensed by integrating all the pixel electrodes and sensing the electrostatic capacitance in the standby mode; and
a display mode switching step of switching to the display mode when the proximity of the touch object is sensed by integrating all the pixel electrodes and sensing the electrostatic capacitance in the power save mode.

33. The display panel of claim 11, further comprising:
a color filter arranged on a side facing the common substrate on the pixel substrate.
